(19) United States
(12) Patent Application Publication
(10) Pub. No.: US 2007/0228224 A1
(43) Pub. Date: Oct. 4, 2007

(54) Release cable universal joint mechanism

(76) Inventor: Marco Lehmann, London (CA)

Correspondence Address: GIFFORD, KRASS, SPRINKLE,ANDERSON & CITKOWSKI, P.C, PO BOX 7021, TROY, MI, 48007-7021, US

(21) Appl. No.: 11/395,095

(22) Filed: Mar. 31, 2006

(51) Int. Cl. F16L 3/00

(52) U.S. Cl. 248/49

(57) ABSTRACT

A universally adjustable joint mechanism for supporting a linearly displaceable and braided wire cable including a first fixed component having a three-dimensional shape and size and exhibiting an interior extending passageway. A second component has a further three-dimensional shape and size and defines a communicating a second interior extending passageway. The second component is pivotally secured to the first component about a first axis defined by respective pairs of linearly extending and overlapping edges, and such that the braided wire cable extends successively through the end-to-end communicating and interior extending passageways associated with the pivotally secured components, and in a substantially non-linear extending fashion.

### BACKGROUND OF THE INVENTION

1. Field of the Invention

The present invention relates generally to an angularly/universally position adjustable mechanism for use with a slidable/translatable cable. More specifically, the present invention discloses a universal joint mechanism securing a sliding cable in any desired angular (substantially non-linear) fashion, and such as to permit smooth translating motion of the cable for use in a latch release or other suitable application.

2. Description of the Prior Art

The prior art cites certain examples of universal adjustable assemblies, such as in use with an interiorly positioned cable or line. The intention of such assemblies is to prevent kinking or damage to the cable extending in a substantially non-linear fashion.

A first example of the prior art is set forth in European Patent Application 0 780 949 which teaches a tubular cable adapter for use in jointing and/or terminating medium voltage cables and including a first outer elastic insulating tubular member having a smooth outer surface and a second likewise elastic tubular member. A tubular support core means maintains the first and second tubular members in a radially expanded state, and is removable from the first and second tubular members. The first tubular member further includes an outer layer and in insulating conformable material interposed between the outer layer and the hollow tubular core, the outer surface of the first tubular member extending substantially parallel to the tubular core means.

U.S. Pat. No. 5,141,258, issued to Stine, teaches an expansion coupling for joining the ends of a pair of first and second conduits along a longitudinal axis. Each of the conduits exhibits a tubular member having a circular cross sectional shape and further having an outside threaded leading end and an outside threaded trailing end. The coupling further includes an inner and outer sleeve, both of which are elongated tubular members having a first end in the form of an internally threaded throat adapted to receive a respective threaded end of a respective conduit. The inner sleeve has a second end exhibiting a square outer periphery.

The outer sleeve also has a second end exhibiting a square outer periphery. The second end of the inner sleeve is arranged for disposition within the second end of the outer sleeve to readily slide with respect thereto along the longitudinal axis, with the contiguous surfaces of the second ends of both sleeves preventing the rotation of the sleeves with respect to each other about the longitudinal axis.

Finally, European Patent Application No. 0 823 762 teaches a corner joint for a cable duct exhibiting a cross section mainly in the shape of a “U” and consisting of a body and two flanges. The corner joint includes a segment of a tube defining an axis, which is parallel to the body, as well as two corner joint parts being placed after each other and pivotally around the axis of the tube. The corner joint permits assembly of straight duct parts in corners and along an angle within a predetermined range.

### SUMMARY OF THE PRESENT INVENTION

The present invention discloses a universally adjustable joint mechanism for supporting such as a linearly displaceable and braided wire cable, such as in particular associated with a latch release mechanism. The invention further applies a cable alternatively and/or additionally rotatable about its longitudinal (or coaxial extending) axis. In particular, the present invention renders possible repositionable adjustment of the joint mechanism including first and second pivotally secured and repositionable members about at least one of first and second perpendicular axes, and in order to maintain the ability of the cable to slide or translate along a specified and substantially non-linear range between a first inlet end and a second outlet end.

A first fixed component exhibits a three-dimensional shape and size with an interior extending passageway. A second component has a further three-dimensional shape and size and defines a communicating a second interior extending passageway. Each of the components are constructed from such as a plasticized material and may include respective split halves ultrasonically welded together.

The second component is pivotally secured to the first component about a first axis defined by respective pairs of linearly extending and overlapping legs, and such that the cable extends successively through the end-to-end communicating and interior extending passageways associated with the pivotally secured components. Additional features include first selected legs exhibiting a laterally projecting male portion having an outer annular circumference. Second selected and pivotally engaging legs each further exhibit a female receiving portion, within which the laterally projecting portions seat.

Each of the laterally projecting portions further include a lead angle extending from the outer annular circumference, and in a direction towards a central and outermost location corresponding with the first axis. Each of the female receiving portions further exhibit a circular aperture, against an inner extending surface of which abuttingly contacts the outer annular circumference and lead angle associated with the associated laterally projecting portion.

Also provided is a lengthwise extending and annular recess opposite the first pivotal axis. A sleeve shaped conduit secures within the recess and provides a guide for the cable extending therethrough.

### BRIEF DESCRIPTION OF THE DRAWINGS

Reference will now be made to the attached drawings, when read in combination with the following detailed description, wherein like reference numerals refer to the like parts throughout the several views, and in which:

FIG. 1 is a perspective view of the universal joint mechanism according to a preferred embodiment of the present invention;

FIG. 2 is an exploded view of the mechanism illustrated in FIG. 1 and showing the first and second pivotally adjustable components for slidably receiving the cable;

FIG. 3 is a side plan view of FIG. 1 and illustrating the pivotal nature of the mechanism;

FIG. 4 is a bottom view and showing the inter-engaging structure for permitting pivoting of the first and second components;

FIG. 5 is an internal cutaway view taken along line 5-5 of FIG. 3 and illustrating the architecture established between the pivotal components;

FIG. 6 is an enlarged partial view of FIG. 5;

FIG. 7 is a rotated perspective view of a universal joint mechanism according to a further preferred variant and showing an alternately configured keyway features associated with the first (fixed) component; and

FIG. 8 is a cutaway view taken along line 8-8 of FIG. 3 and illustrating the manner in which the translatable cable is supported within the second (pivoting) component and associated conduit secured to the second component.

### DETAILED DESCRIPTION OF THE PREFERRED EMBODIMENTS

Referring now to FIG. 1, a perspective view is shown generally at 1 of a universal joint mechanism according to a preferred embodiment of the present invention. As previously described, the joint mechanism 1 supports such as a linearly displaceable and braided wire cable 5, associated with a latch release mechanism or any other suitable application (not shown) by which desires the ability to reroute a stiff, compressive wire cable in a non-linear extending fashion. The joint mechanism likewise facilitates rotation of the cable 5 as either an alternative or an additional component to the translational support of the cable.

FIG. 1 illustrates, at opposite extending ends of the cable 5, the linear displaceable directions associated with the cable according to the present invention and such as by which a lever (not shown) located at a first remote direction associated with the cable 5 is capable of actuating the cable in either of first or second translating directions and in order to actuate a latch or other displaceable mechanism located at an opposite remote direction (also not shown). The present invention renders possible repositionable adjustment of a pair of pivotally, see fixed 4 and pivotally repositionable 3 members, about at least one of a first α and a second β (see again FIG. 1) respectively perpendicular axes, this in order to maintain the ability of the cable 5 to slide or translate along a specified and substantially non-linear range between first inlet end 5 and second outlet end 5′ locations of the continuously extending cable (see again FIG. 1).

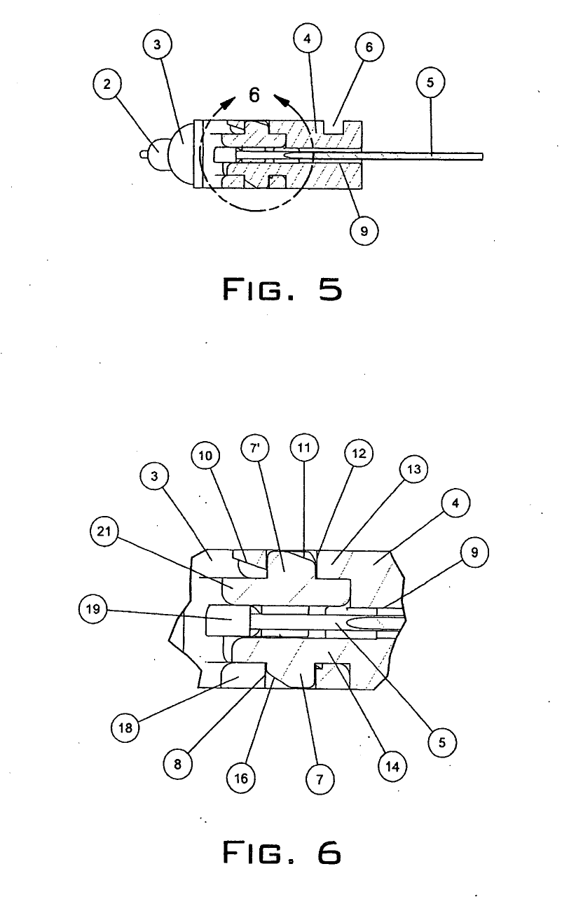

As is further referenced throughout the succeeding perspective and plan views, a first fixed component, see again as shown at 4, exhibits a three-dimensional shape and size with an interior extending (lengthwise) passageway 9 (see as is also best shown in cutaway in FIG. 5). The first component 4 may also exhibit a three-dimensional shape and size and exhibit a cross sectional and annular shaped neck (see inner recess established by outer annular surface 6), this being adapted to being secured at a given fixed location (not shown) and further such as a metal stamping location or the like.

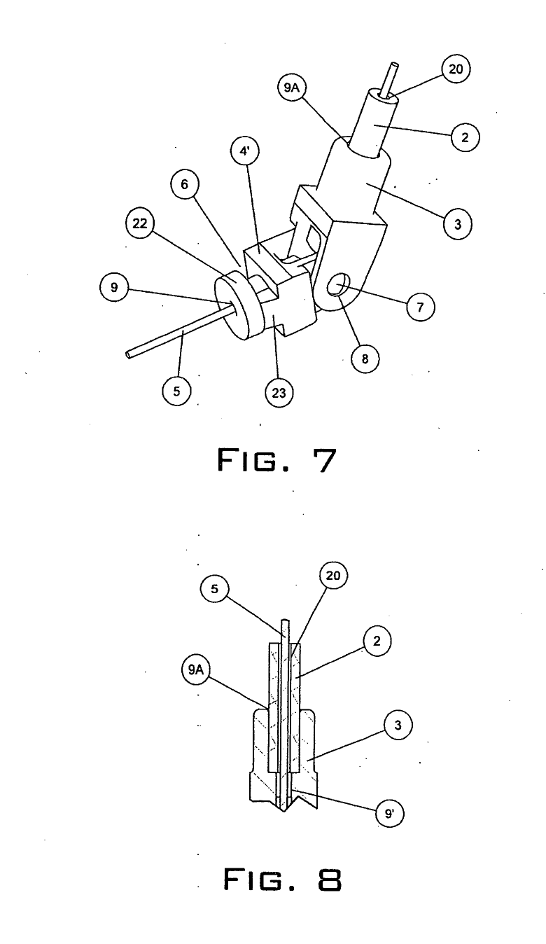

Given the annular configuration 6 of the neck, it is contemplated that the fixed 4 and pivotally secured 3 components are capable of being readjustable about axis β separate and perpendicular from a pivotal axis α defined between the components 3 and 4, this giving rise to the universal readjustability aspect of the mechanism. It is envisioned that any degree of pivoting motion about first axis α is possible between the components 3 and 4, in one non-limiting variant being in a range up to approximately 180°, more or less. Alternatively, and referring to the configuration of FIG. 7, first component 4′ having a three-dimensional shape and size and again includes a cross sectional shaped neck exhibiting a modified keyway surface 23 for securing the component to a fixed location and in either an immovable or only partially adjustable fashion separate from the pivotal readjusting aspects provided between the components 3 and 4 along the α axis.

The second (adjustable) component 3 likewise includes a further three-dimensional shape and size and defines a communicating a second interior extending passageway, see at 9′ in FIG. 8. A lengthwise extending and annular recess, at 9A in FIG. 8, is shown extending through an end opposite the first pivotal axis α. A sleeve shaped conduit 2, typically constructed of a plasticized, e.g. nylon material, secures within the recess 9A in order to provide a guide, see also interior surface 20, for receiving the sliding cable 5 extending therethrough.

Although not shown, it is further understood that each of the components 3 and 4 are constructed from such as a plasticized material and may include respective split halves which are capable of being ultrasonically welded together. It is also envisioned that the components herein may be constructed of a die cast metal. Possible manufacturing techniques, such as certain types of injection molding or stamping processes, are also contemplated for creating parts exhibiting the desired configuration.

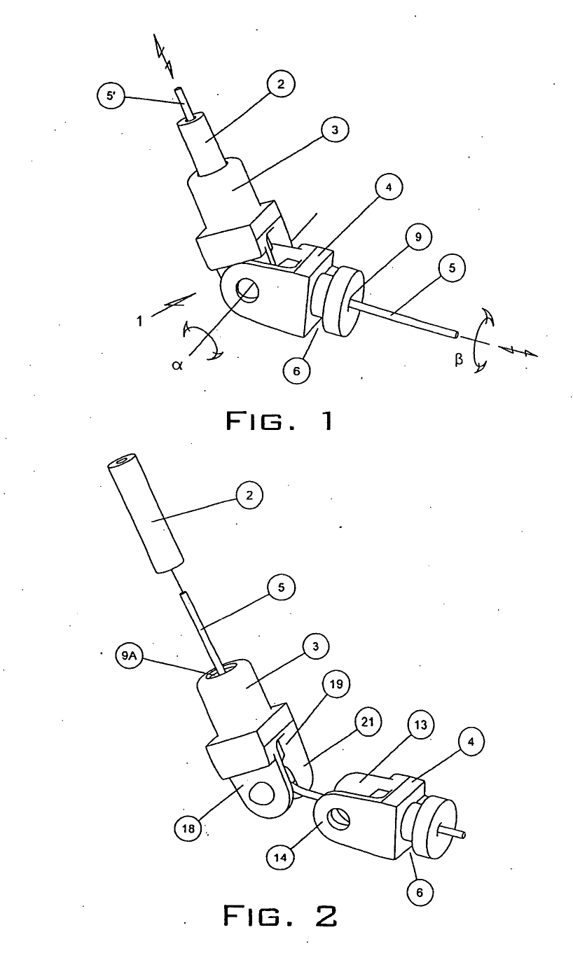

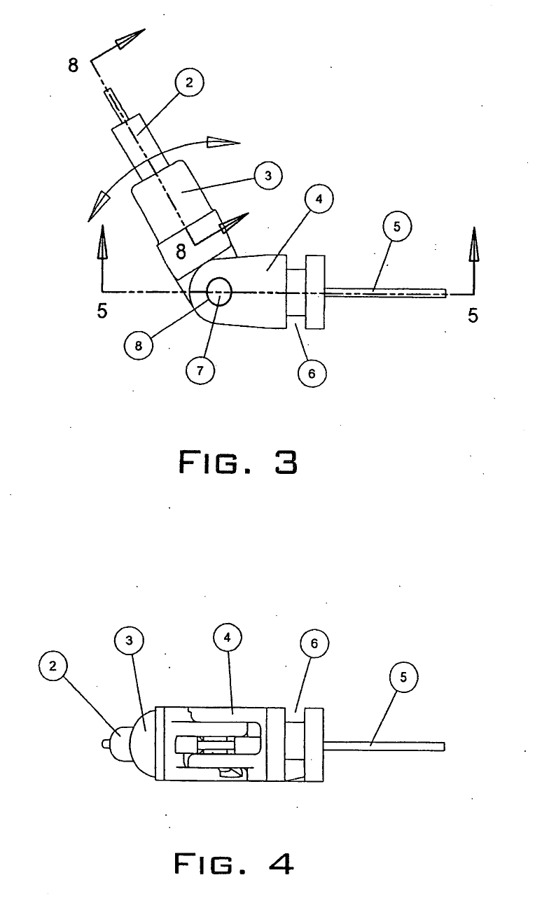

To facilitate pivotally securing the second component 4 to the first component 3 about the first axis α, respective pairs of linearly extending and overlapping legs, see as shown at 13 and 14 for fixed member 4, as well as at 18 and 21 for pivotal member 3 in the exploded view of FIG. 2. As is illustrated throughout the several views, the configuration of the legs 13 & 14 and 18 & 21 are such that they extend in laterally offsetting and overlapping fashion in order to assemble into a pivotally repositionable assembly and by which respective interior cable extending passageways are communicating in end-to-end fashion for facilitating non-linear travel of the sliding cable 5.

Additional features include first selected legs 14 and 21 (see also FIG. 6) exhibiting a laterally (outwardly) projecting male portion, see at 7 and 7′, each having an outer annular circumference. Second selected and pivotally engaging legs 13 and 18 each further exhibit a female receiving portion (see further inner annular surfaces 12 and 8, respectively and defining inner circular apertures as shown in FIG. 6) within which the outwardly laterally projecting portions 7 and 7′ seat.

Each of the laterally projecting portions further include a lead angle, see at 16 for portion 7 and at 11 for portion 7′, each of which further extending from a location corresponding to the outer annular circumference and in a direction towards a central and outermost laterally projecting location corresponding with the first axis α. Each of the female receiving portions again exhibit an outer circular aperture, against an inner extending surface of which abuttingly contacts an associated and outer annular circumference and lead angle associated with each of the laterally projecting portions 7 and 7′.

The configuration of the projecting portions 7 and 7′ with lead angles 16 and 11, respectively, are such that a controlled degree of resistance is provided due to their biasing engagement (this occurring between along the surface of the lead angles contacting the inner annular walls defining the female axial receiving portions), and further such that the components 3 and 4 are capable of being securely supported at any desired pivotal position. Additional features include the provision of a centrally located, inner contoured and support surface 19, this being associated with pivotal component 3, and which provides a shoulder along which the non-linear extending portion of the cable 5 is supported between the inlet location associated with the fixed component 4 and the outlet location associated with the pivotally readjustable component 3.

Having described my invention, it is evident that it discloses a universal and adjustable joint mechanism, capable of being effectively mounted at any suitable location, and in order to support and redirect in non-linear fashion an intermediate extending portion associated with a compressible/translatable cable (as well as a likewise tensionable cable). The joint mechanism is constructed such that the adjoining and interior conduit/cable extending passageways support the cable in non-linear extending and kinking/damage preventative fashion, while still permitting the cable to be easily translated in response to either a compressive or tensioning input at either selected end. It is further envisioned that the provision of one or more supporting mechanisms as described herein can be positioned at either end or intermediate location(s) along a traveling length of the cable 5 and in order to support the same at any desired locations.

Having described my invention, other and additional preferred embodiments will become apparent to those skilled in the art to which it pertains, and without deviating from the scope of the appended claims.

I claim:

1. An adjustable joint mechanism for supporting a linearly displaceable cable, comprising:
a first component defining an interior extending passageway and being secured to a fixed location; and
a second component defining a further interior extending passageway, said second component being pivotally secured to said first component about a first axis such that the cable extends through said interior extending passageways associated with said first and second components in substantially non-linear extending fashion.

2. The mechanism as described in claim 1, said first component exhibiting a three-dimensional shape and size and further comprising a cross sectional and annular shaped neck adapted to being secured at the fixed location to permit said first and second components to pivot about a second axis extending perpendicular relative to said first axis in a combined universal fashion.

3. The mechanism as described in claim 1, each of said first and second components exhibiting a three-dimensional shape and size and further comprising a pair of linear extending and overlapping legs, collectively defining said first pivot axis.

4. The mechanism as described in claim 3, further comprising first selected legs exhibiting a laterally projecting male portion having an outer annular circumference, second selected and pivotally engaging legs each exhibiting a female receiving portion within which said projecting portions seat.

5. The mechanism as described in claim 4, each of said laterally projecting portions further comprising a lead angle extending from said outer annular circumference towards a central and outermost location corresponding with said first axis.

6. The mechanism as described in claim 5, each of said female portions further comprising a circular aperture, against an inner extending surface of which abuttingly contacts said outer annular circumference and lead angle associated with said associated laterally projecting portion.

7. The mechanism as described in claim 1, said second component exhibiting a specified shape and size and possessing a lengthwise extending and annular recess opposite said first pivotal axis, a sleeve shaped conduit securing within said recess and providing a guide for the cable extending therethrough.

8. The mechanism as described in claim 7, said cable exhibiting a specified shape and size and being constructed of at least one of a durable plasticized and a nylon material.

9. The mechanism as described in claim 1, said first component having a three-dimensional shape and size and further comprising a cross sectional shaped neck exhibiting a modified keyway surface for securing to the fixed location.

10. The mechanism as described in claim 1, each of said first and second components exhibiting a three-dimensional shape and size and being constructed of a durable plastic material.

11. The mechanism as described in claim 1, each of said first and second components exhibiting a three-dimensional shape and size and further comprising first and second linearly split pieces assembled in an ultrasonic welded fashion.

12. An adjustable joint mechanism for supporting a linearly displaceable and braided wire cable, comprising:
a first component having a three-dimensional shape and size and exhibiting an interior extending passageway, said first component adapted to being secured to a fixed location; and
a second component having a further three-dimensional shape and size and defining a communicating and further interior extending passageway, said second component being pivotally secured to said first component about a first axis defined by respective pairs of linearly extending and overlapping edges;
the braided wire cable extending successively through said interior extending passageways associated with said first and second components in substantially non-linear extending fashion.

13. The mechanism as described in claim 12, further comprising first selected legs exhibiting a laterally projecting male portion having an outer annular circumference, second selected and pivotally engaging legs each exhibiting a female receiving portion within which said projecting portions seat.

14. The mechanism as described in claim 13, each of said laterally projecting portions further comprising a lead angle extending from said outer annular circumference towards a central and outermost location corresponding with said first axis.

15. The mechanism as described in claim 14, each of said female portions further comprising a circular aperture, against an inner extending surface of which abuttingly contacts said outer annular circumference and lead angle associated with said associated laterally projecting portion.

16. The mechanism as described in claim 12, said second component exhibiting a specified shape and size and possessing a lengthwise extending and annular recess opposite said first pivotal axis, a sleeve shaped conduit securing within said recess and providing a guide for the cable extending therethrough.

17. The mechanism as described in claim 16, said cable exhibiting a specified shape and size and being constructed of at least one of a durable plasticized and a nylon material.

18. The mechanism as described in claim 12, said first component having a three-dimensional shape and size and further comprising a cross sectional shaped neck exhibiting a modified keyway surface for securing to the fixed location.

19. The mechanism as described in claim 12, each of said first and second components exhibiting a three-dimensional shape and size and further comprising first and second linearly split pieces of plasticized material assembled in an ultrasonic welded fashion.

20. An adjustable joint mechanism for supporting a linearly displaceable cable, comprising:
a first component defining an interior extending passageway; and
a second component pivotally interconnected with said first component and further defining a second interior extending passageway;
the cable extending through said interior extending passageways in substantially non-linear extending fashion.
